(19) United States
(12) Patent Application Publication
(10) Pub. No.: US 2007/0143002 A1
(43) Pub. Date: Jun. 21, 2007

(54) System for evaluating and improving driving performance and fuel efficiency

(76) Inventors: Thomas J. Crowell, Metamora, IL (US); Steven J. Funko, Mapelton, IL (US); Scott Alan Leman, Eureka, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/312,759

(22) Filed: Dec. 21, 2005

(51) Int. Cl. G06F 19/00

(52) U.S. Cl. 701/123; 701/50

(57) ABSTRACT

A method for monitoring driving performance is provided. The method may include determining an engine fuel efficiency based on an engine speed and power output and determining a transmission fuel efficiency based on a drive ratio. A drive-train fuel efficiency may be determined based on the engine fuel efficiency and transmission fuel efficiency, and the drive-train efficiency may be compared to a target drive-train efficiency.

### TECHNICAL FIELD

This disclosure pertains generally to systems for evaluating fuel efficiency, and more particularly, to systems for evaluating fuel efficiency of highway vehicles.

### BACKGROUND

Highway trucks travel many miles and often carry heavy loads. Consequently, fuel expenditures comprise a significant part of the operating expenses for many truck fleets. The overall fuel efficiency of a highway truck may depend upon a variety of different factors, such as the vehicle route, vehicle speed, weight, engine type, weather conditions, and fuel composition. Further, the skill of a driver can have a significant effect on fuel efficiency, and consequently, on fuel cost and profitability.

Since truck drivers may travel across different routes, carry different loads, and/or operate different vehicles, it can be very difficult for fleet managers to assess driver performance as it relates to fuel efficiency. Further, individual drivers need objective evaluations of their driving abilities in order to recognize inefficient driving habits and optimize fuel efficiency. Therefore, improved systems for evaluating driving performance to improve fuel efficiency are needed.

One system for evaluating vehicle operating conditions is disclosed in U.S. Patent Publication 2005/0021222, which was filed on Jul. 24, 2003 by Minami (hereinafter the '222 publication). The '222 publication includes a calculation unit that determines whether or not an operation that worsens fuel economy has be performed. If an operation which worsens fuel economy occurs, the calculation unit calculates the actual amount of fuel consumed and an amount of fuel that would have been consumed had the operation that worsens fuel economy not been performed.

Although the system of the '222 publication may provide a useful tool for evaluating fuel efficiency, the system of the '222 publication may have several drawbacks. For example, the system of the '222 publication does not provide a means for fleet managers to compare driver performance. Further, the system of the '222 publication may indicate when inefficient engine operations occur, but the system of the '222 publication does not consider the contribution of the transmission to the overall drive-train efficiency of a vehicle. In addition, although the system of the '222 publication may help identify inefficient driving, it cannot predict upcoming road conditions that may affect fuel efficiency.

The present disclosure is directed at overcoming one or more of the shortcomings of the prior art fuel-efficiency monitoring systems.

### SUMMARY OF THE INVENTION

A first aspect of the present disclosure includes a method for monitoring driving performance. The method may include determining an engine fuel efficiency based on an engine speed and power output and determining a transmission fuel efficiency based on a selected drive ratio. A drive-train fuel efficiency may be determined based on the engine fuel efficiency and transmission fuel efficiency, and the drive-train efficiency may be compared to a target drive-train efficiency.

A second aspect of the present disclosure includes a system for monitoring driving performance. The system may include at least one engine sensor configured to monitor at least one engine-operating parameter and at least one transmission sensor configured to monitor at least one transmission-operating parameter. The system may further include a control unit configured to determine a drive-train efficiency based on the at least one engine-operating parameter and the at least one transmission-operating parameter.

A third aspect of the present disclosure includes a work machine. The machine may include an engine and a transmission operably connected to the engine, and a system for monitoring driving performance. The system for monitoring driving performance may include at least one engine sensor configured to monitor at least one engine-operating parameter and at least one transmission sensor configured to monitor at least one transmission-operating parameter. The system may further include a control unit configured to determine a drive-train efficiency based on the at least one engine-operating parameter and the at least one transmission-operating parameter.

A fourth aspect of the present disclosure includes a method for monitoring driving performance. The method may include determining a machine location using a positioning system and evaluating current machine-operating parameters. At least one machine-operating instruction may be determined based on the machine location and operating parameter.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosed system. In the drawings:

FIG. 1 illustrates a work machine including a fuel-efficiency monitoring system, according to an exemplary disclosed embodiment.

FIG. 2 provides a block diagram of a fuel-efficiency monitoring system, according to an exemplary disclosed embodiment.

FIG. 3 illustrates a method for monitoring a drive-train efficiency and an operator efficiency score, according to an exemplary disclosed embodiment.

FIG. 4 illustrates an engine fuel efficiency map.

FIG. 5 illustrates a method for improving driving efficiency, according to an exemplary disclosed embodiment.

### DETAILED DESCRIPTION

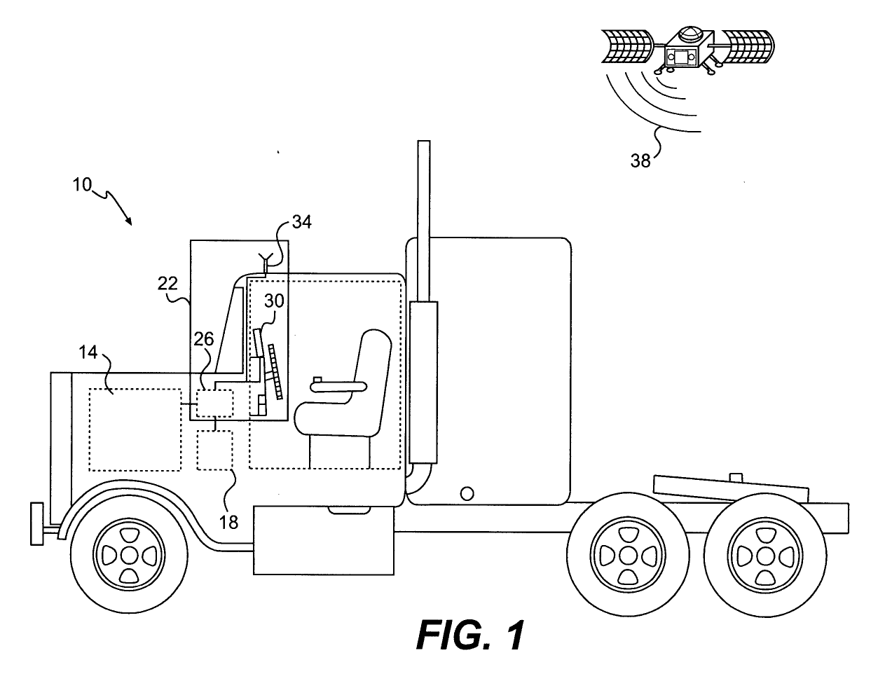

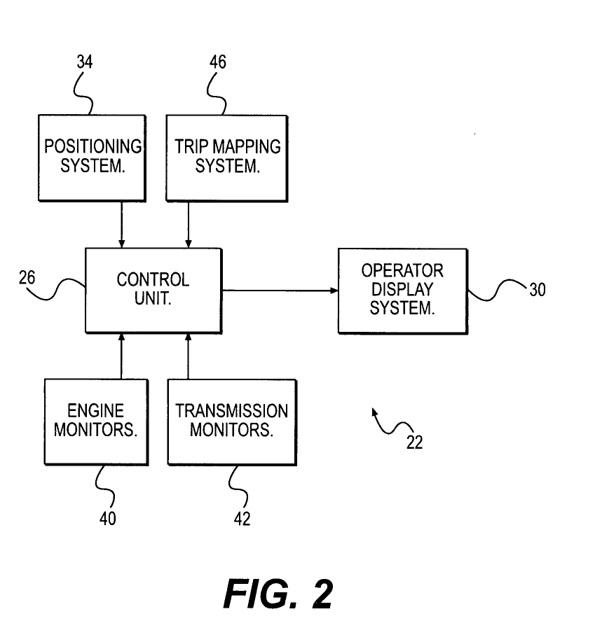

FIG. 1 illustrates a work machine 10, according to an exemplary disclosed embodiment. As shown, work machine 10 is a highway truck, which includes an engine 14 and transmission 18. Work machine 10 further includes a fuel-efficiency monitoring system 22 configured to monitor the work machine fuel efficiency and to assist a machine operator in driving more efficiently. As described in detail with reference to FIG. 2, fuel-efficiency monitoring system 22 may include a number of components, including for example, a control unit 26, a display unit 30, and/or a positioning system 34.

Fuel-efficiency monitoring system 22 may be configured to monitor, record, and/or output information related to operational parameters of engine 14 and/or transmission 18. For example, in some embodiments, fuel-efficiency monitoring system 22 may be configured to monitor the fuel efficiency of engine 14 and transmission 18 and to calculate a drive-train fuel efficiency based on the engine efficiency and transmission efficiency. Further, fuel-efficiency monitoring system 22 may compare the drive-train fuel efficiency to a target or predicted optimum fuel efficiency. Further, in some embodiments, fuel-efficiency monitoring system 22 may be configured to determine, record, and/or output information related to the driving performance of a machine operator based on the difference between the actual fuel efficiency and target fuel efficiency.

Engine 14 may include, for example, a diesel engine, a gasoline engine, a gaseous fuel driven engine, or any other engine known in the art. Engine 14 may be configured to supply power to work machine 10. It is contemplated that engine 14 may include one or more piston-cylinder arrangements disposed in an “in-line” or “V” configuration defining combustion chambers and connected to a crankshaft, one or more valves operatively associated with the combustion chambers to affect the flow of fluids into and out of the combustion chambers, and a fuel delivery system configured to deliver fuel to the combustion chamber as is conventional in the art. It is also contemplated that engine 14 may be capable of operating in a number of different modes in which operational parameters, such as, for example, fuel delivery timing, valve timing, ignition timing, clean exhaust recirculation amounts, fuel amounts, and/or any other parameter known in the art may be varied to control engine performance.

Transmission 18 may also include any suitable transmission type. For example, transmission 18 may include a traditional transmission with a certain number of discrete gears. Further, any suitable number of gears may be selected based on cost, type of engine being used, and/or expected operational demands. Further, in some embodiments, transmission 18 may include a continuously variable transmission, which can provide an unlimited number of drive ratios for operation of machine 10. As described herein, a machine may operate at a specific drive ratio based on the condition of a continuously variable transmission or the specific gear of a traditional gearbox transmission.

FIG. 2 illustrates a block diagram of fuel-efficiency monitoring system 22. As noted previously, fuel-efficiency monitoring system 22 may include a control unit 26, an operator display system 30, and/or a positioning system 34. In addition, fuel-efficiency monitoring system 22 may include one or more engine monitors 40, one or more transmission monitors 42, and/or a trip-mapping system 46.

Control unit 26 may include a variety of suitable machine electronic control units. For example, control unit 26 may include one or more microprocessors, a memory unit, a data storage device, a communications hub, and/or other components known in the art. It is contemplated that control unit 26 may be integrated within a general control system capable of controlling various functions of engine 14 and/or other components of work machine 10. Further, control unit 26 may perform one or more algorithms to determine appropriate output signals to affect the operation of engine 14 and/or transmission 18, and may deliver the output signals via suitable communication lines.

Control unit 26 may be configured to communicate with other components of fuel-efficiency monitoring system 22. For example, control unit 26 may be configured to receive input signals from engine and transmission monitors 40, 42, positioning system 34, and/or trip-mapping system 46 via respective communication lines. Further, control unit 26 may be configured to output information related to machine operation to operator display unit 30. In addition, control unit 26 may be configured to store information to be downloaded or viewed by drivers and/or fleet managers.

Engine and transmission monitors 40, 42 may include a variety of different monitor types. For example, engine monitors 40 may include any conventional sensor configured to deliver a signal indicative of an operating parameter of engine 14. Engine monitors 40 may be disposed adjacent to or within components of engine 14 and configured to communicate signals indicative of one or more engine parameters, such as, rotational speed of a crankshaft, valve position, air-fuel ratio, temperature, pressure, and/or any other parameter known in the art. As described below, the efficiency of engine operation may be related to certain engine-operating parameters, including for example, engine power output and rotation speed. Therefore, engine monitors 40 may be configured to detect engine power, rotation speed, engine load, engine torque and/or any other parameter that may be correlated with engine fuel efficiency.

Transmission monitors 42 may also include any suitable transmission sensor. For example, the fuel efficiency of a truck is in part due to the efficiency of power transmission from an engine through transmission 18. For a selected transmission system and drive ratio, a transmission efficiency may be known or determined by experimentation. Transmission monitors 42 may be configured to monitor the drive ratio and/or gear being used and to communicate a signal indicative of the drive ratio and/or gear to control unit 26. Further, transmission monitors 42 may be configured to detect a change in drive ratio and/or gear and to communicate the change to control unit 26.

It should be noted that transmission monitors 42 may be configured to monitor the transmission drive ratio and/or gear directly, or to determine the drive ratio and/or gear based on other machine-operating parameters. For example, in some embodiments, a gear or drive ratio may be determined based on a vehicle speed and engine speed. Therefore, transmission monitors 42 may include a vehicle speedometer and/or engine speed monitor. The speedometer and engine speed monitor may provide signals to control unit 26 representing a vehicle speed and engine speed, and control unit 26 may determine the current drive ratio and/or gear based on the vehicle speed and engine speed.

As noted previously, fuel-efficiency monitoring system 22 may also include a positioning system 34. Positioning system 34 may include a variety of suitable positioning system types. For example, positioning system 34 may include a global positioning system, which may receive signals from one or more satellites 38 (as shown in FIG. 1) or other positioning system communications units to determine the location of work machine 10. Any suitable positioning system 34 may be selected.

In addition, fuel-efficiency monitoring system 22 may also include trip-mapping system 46. Trip-mapping system 46 may include, for example, an on-board computer or memory storage unit configured to store information related to a path to be traveled by work machine 10. For example, trip-mapping system 46 may include a data storage system including maps of roads and/or highways to be traveled. Trip-mapping system 46 may be included in a separate piece of hardware or integrated with positioning system 34 and/or control unit 26.

In some embodiments, trip-mapping system 46 may further include information related to driving conditions for selected roads or highways. For example, in some embodiments, trip-mapping system 46 may include information that may assist a driver in selecting a route and/or controlling machine operation to improve fuel efficiency. Such information may include, for example, speed limits, construction patterns, predicted traffic delays, the grade or size of inclines or declines, curves that may require a change of speed, distance to trip end points, weigh-station locations, and/or any other information that may assist a driver in selecting a route or controlling fuel efficiency.

Fuel-efficiency monitoring system 22 may also include operator display system 30. Operator display unit 30 may be configured to receive information from control unit 26 and/or other components of fuel-efficiency monitoring system 22 and to output the information to a machine operator. For example, display unit 30 may be configured to display one or more engine and/or transmission-operating parameters, including for example, a selected drive ratio, a selected gear, a measure of engine fuel efficiency, a measure of transmission efficiency, current drive-train efficiency, and/or total machine fuel consumption rate. In additional, display unit 30 may be configured to display a comparison of current fuel efficiency versus a target or predicted optimum fuel efficiency. Further, display unit 30 may be configured to display a fuel efficiency score, which may be indicative of a driver's performance compared to a target or predicted optimum performance.

Display unit 30 may include a variety of suitable display types. For example, in some embodiments, display unit 30 may include a visual display system such as digital display. In addition, display unit 30 may be configured to provide audible signals indicative of the efficiency of driver operation. Further, display unit 30 may display information related to vehicle location and/or road conditions, as provided by positioning system 34 and/or trip-mapping system 46.

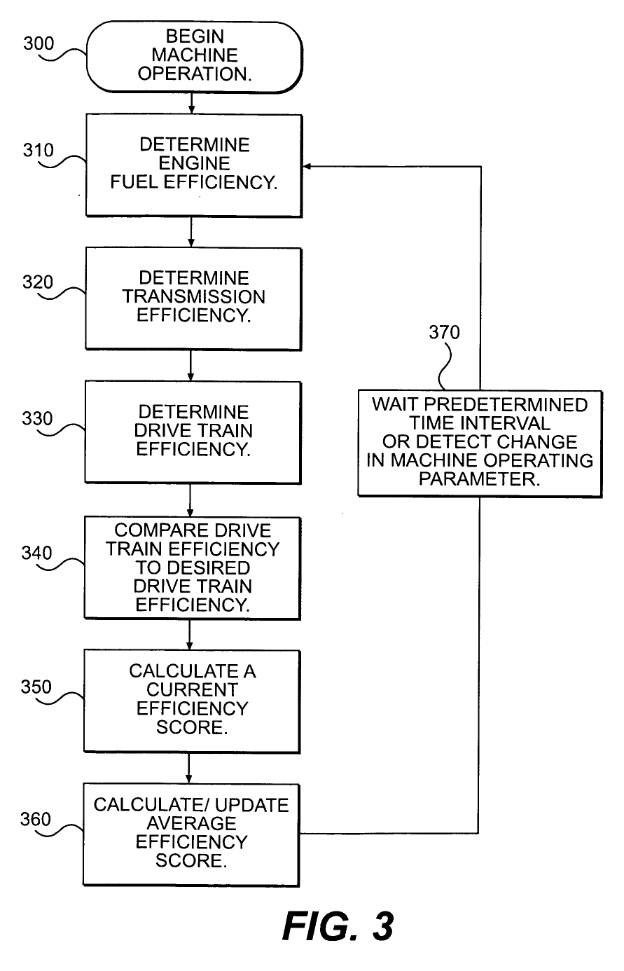

As noted, fuel-efficiency monitoring system 22 may be configured to monitor the efficiency of engine and transmission operation, and to determine a machine drive-train efficiency. FIG. 3 illustrates a method for monitoring the drive-train efficiency of work machine 10, according to an exemplary disclosed embodiment. As shown at step 300, fuel-efficiency monitoring system 22 may begin operation when a truck or other machine is turned on. In some embodiments, monitoring system 22 may be configured to operate continuously any time a machine is in use. Alternatively, monitoring system 22 may be configured to monitor and/or record machine efficiency only during selected periods of operation. For example, monitoring system 22 may be configured to monitor and/or record fuel efficiency only during relatively long, uninterrupted driving, such as long-distance highway driving. Further, monitoring system 22 may stop monitoring and/or recording operating efficiency during periods of significant stop-and-go traffic, as may occur in areas with heavy traffic or difficult to navigate roadways.

As noted previously, the overall drive-train efficiency of work machine 10 may be due to a number of factors. For example, drive-train efficiency may be due to current engine-operating conditions, the type of transmission being used, the current drive ratio and/or gear, fuel type, temperature, and/or a variety of other factors. In some embodiments, monitoring system 22 may be configured to determine an engine fuel efficiency and a transmission fuel efficiency, as shown at steps 310 and 320. Subsequently, a drive-train efficiency may be determined based on the engine efficiency and transmission efficiency, as shown at step 330.

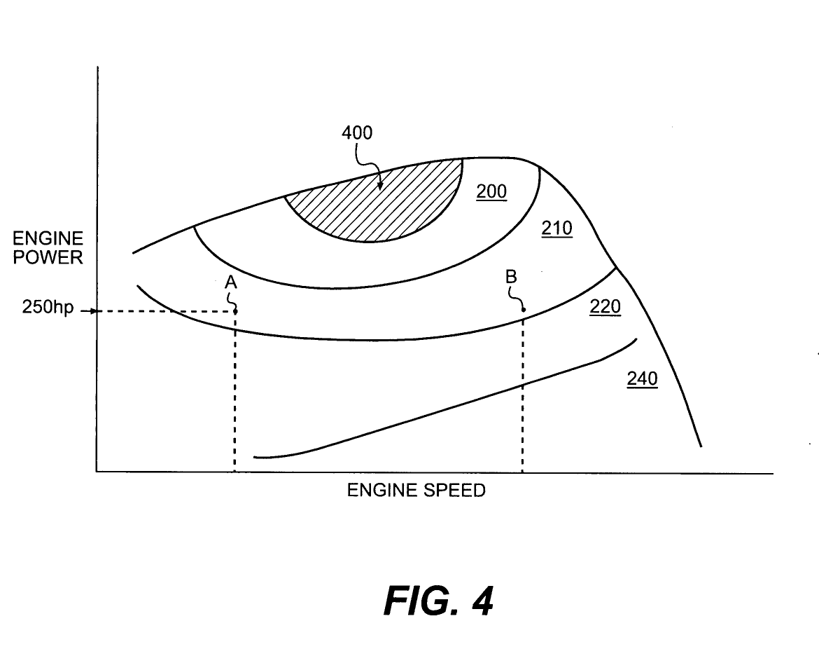

An engine fuel efficiency may be determined using a variety of methods. For example, engine efficiencies are often evaluated using a laboratory testing machine, which can be used to produce an engine efficiency map, as shown in FIG. 4. As shown, the engine efficiency is expressed as the brake specific fuel consumption (BSFC), which is indicated by the lines in FIG. 4. A variety of different units may be used to map engine BSFC. As shown, the BSFC of an engine may be plotted using the engine power (Y-axis) versus engine speed (X-axis).

It should be noted that the BSFC map for an engine may vary. For example, the specific map may be based on the specific engine manufacturer and model. Further, the BSFC map may change due to modifications, such as changes in fuel, combustion strategy, temperature, air flow, and/or a variety of other factors. The BSFC map of FIG. 4 is illustrative of a typical BSFC map appearance but does not represent any specific engine.

For a given engine power output, the fuel efficiency may vary based on operator performance. For example, as shown in FIG. 4, points A and B both represent a 250 horsepower (hp) power output. However, the engine speed at point B is significantly higher than the speed at point A. Therefore, at point B, the operator may be using too low of a gear, thereby sacrificing fuel efficiency. In addition, for each engine, a region of optimum fuel efficiency may be determined. As shown in FIG. 4, the region of optimum fuel efficiency is demonstrated at region 400.

In some embodiments, control unit 26 may be configured to store data pertaining to engine fuel efficiency for engine 14. The data may be stored using a look-up table or other data structure representative of a fuel-efficiency map. The current engine fuel efficiency may be determined by control unit 26 by comparing engine-operating parameters provided by engine monitors 40 with stored values in control unit 26. Control unit 36 may determine engine fuel efficiency and/or output the fuel efficiency to display unit 30.

The fuel efficiency determined by control unit 26 may be expressed in a number of ways. For example, fuel efficiency may be expressed as BSFC, fuel rate (gallons/hour), or fuel mileage (miles per gallon). Alternatively, the fuel efficiency may be compared to a target fuel efficiency. The target fuel efficiency may be selected based on optimum operating region 400, as indicated on a selected BSFC map. In some embodiments, control unit 26 may express the current engine fuel efficiency as a percentage or fraction of the optimum possible fuel efficiency for a desired power output.

Referring again to FIG. 3, the transmission fuel efficiency may also be determined, as indicated at step 320. Like engine fuel efficiency, transmission efficiency may be determined experimentally using a lab testing system. Generally, transmission efficiency may be expressed as a percentage power transmission. The transmission efficiency may be based on the specific transmission being used and the selected gear. For example, for a given power output, transmission type, and selected gear, a certain percentage will be expected to be delivered to work machine axles.

Subsequently, a work machine drive-train efficiency may be calculated, as shown at step 330. As noted previously, the drive-train efficiency may be determined based on the current engine efficiency and transmission efficiency. For example, using engine and transmission efficiencies expressed as percentages or fractions, the total drive-train efficiency may be approximately equal to the engine efficiency multiplied by the transmission efficiency. Therefore, the drive-train efficiency may be based on both the engine and transmission-operating characteristics.

As shown at step 340, the machine drive-train efficiency may be compared to a target or optimum drive-train efficiency. The desired drive-train efficiency may be determined based on the optimum efficiency region 400 of an engine BSFC map and the most efficient drive ratio for operation within the optimum efficiency region 400. As noted previously, the drive ratio may be determined based on the specific drive ratio of a continuously variable transmission or based on a specific gear selected for a traditional gearbox transmission.

In some embodiments, control unit 26 may be configured to determine an operator efficiency score based on the comparison between the optimum drive-train efficiency and the actual drive-train efficiency, as shown at 350. The operator efficiency score may be based on a number of suitable factors. For example, the operator efficiency score may be based on a standardized value, which may be selected based on continuous operation within an optimum drive-train efficiency. Alternatively, the standardized value may be scaled relative to an experienced driver's fuel efficiency for the same route or similar driving conditions. For example, an operator efficiency score for an experienced driver may be given a score of 100, and scores less than 100 may indicate less efficient driving. Further, since excess vehicle speed may adversely affect fuel economy, the optimum fuel economy may be selected based on operation within the predicted optimum drive ratio within a selected speed range (e.g. within five miles per hour of the posted speed limit).

During driving, an operator's efficiency may be evaluated at periodic intervals or after certain changes in vehicle-operating parameters, and the operator's efficiency score may be updated and/or stored. Further, control unit 26 may be configured to calculate a current efficiency score and/or an average driver efficiency score, as shown at 360. The current efficiency score will represent the difference between the actual drive-train fuel efficiency and the predicted optimum fuel efficiency.

The average efficiency score may be calculated based on a number of variables. For example, the average efficiency may be the numerical average of current fuel efficiency scores measured at selected intervals. Further, control unit 26 may be configured to calculate and or record average efficiency scores representative of a variety of different scenarios. For example, in some embodiments, control unit 26 may be configured to produce an average efficiency score for a selected period of driving, for a single trip, for a particular route that may be repeated periodically, and/or any other suitable factor.

The drive-train efficiency may be evaluated and the average efficiency score may be updated periodically. As shown at 370, the process may be repeated at predetermined time intervals and/or based on detected changes in machine-operating parameters. The length of the predetermined interval may be selected based on the type of driving being performed. For example, during periods of driving on flat highways with little speed variation, the interval may be relatively long. However, during periods of heavy traffic, construction, more significant inclines or declines, and/or any other factor that may cause changes in speed and/or power output demands, the time interval may be relatively short. In some embodiments, the drive-train efficiency may be updated during each calculation loop of a vehicle electrical control module. Typical electrical control module loop times are between about 10 milliseconds and about 30 milliseconds.

Alternatively or additionally, the operator efficiency score may be updated each time certain changes in machine-operating characteristics are detected. For example, in some embodiments, control unit 26 may be configured to determine a machine drive-train efficiency and operator efficiency score each time the engine power output changes by a predetermined amount. In other embodiments, the efficiency score may be updated after detection of changes in other operating parameters, including for example, a change in drive ratio and/or gear, application of a brake, a change in accelerator position, and/or a change in road condition (e.g. an incline, decline, or curve).

In some embodiments, fuel-efficiency monitoring system 22 may be configured to record an operator's efficiency score and/or output a signal indicative of operator performance. For example, control unit 26 may record efficiency scores for individual trips, for predetermined time periods, or for selected routes. Further, a fleet manager may access the recorded efficiency scores to assess driver or fleet performance. For example, in some embodiments a driver may maintain a log of efficiency scores as reported on display unit 30. Alternatively, control unit 26 may be configured to output data pertaining to a driver's efficiency scores to a central computer or record system that may be reviewed by drivers and/or managers. The efficiency score data may be communicated to a fleet manager using any suitable communication system, including for example, a wireless communications system, an electrical connection, or a physical storage media such as a diskette.

As noted previously, fuel-efficiency monitoring system 22 may further include positioning system 34 and trip-mapping system 46. In some embodiments, fuel-efficiency monitoring system 22 may be configured to provide information to a driver regarding future driving conditions based on information provided by positioning system 34 and trip-mapping system 46. Further, in some embodiments, control unit 26 may be configured to determine and output recommended driving instructions based on information provided by positioning system 34 and trip-mapping system 46. The information provided by control unit 26 may assist a driver in monitoring and improving driving performance.

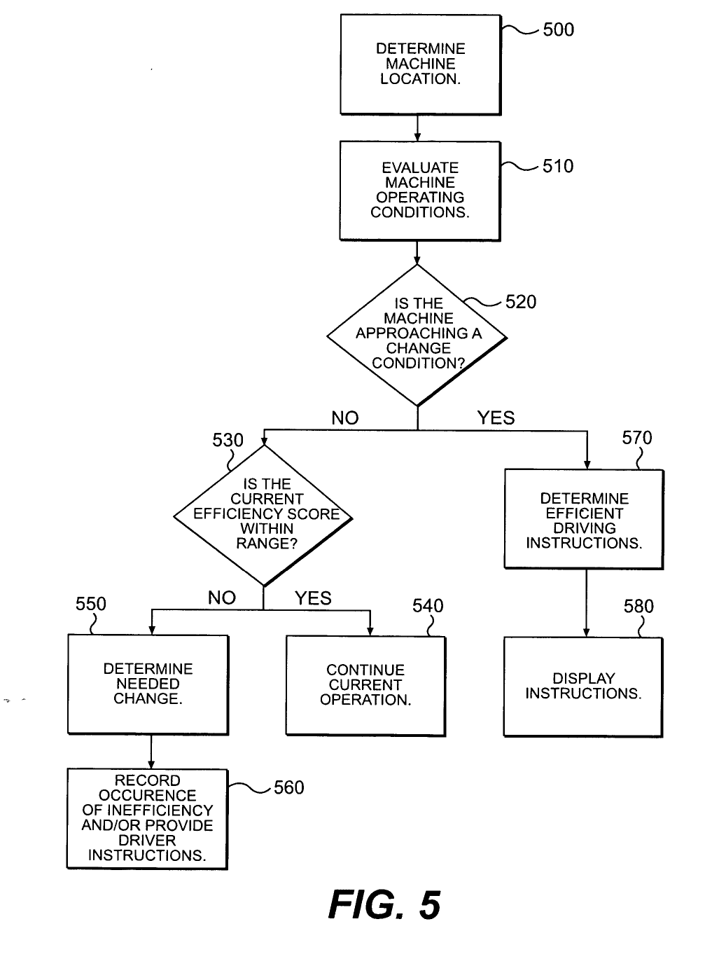

FIG. 5 illustrates a method for improving driving efficiency, according to an exemplary disclosed embodiment. As shown at 500, the method may include determining a work machine location using positioning system 34 and trip-mapping system 46. A signal indicative of the work machine location may be output to control unit 26, and the machine location may be communicated to a driver through display unit 30.

As shown at 510, control unit 26 may next evaluate one or more machine-operating conditions. As described previously, the machine-operating conditions may include an engine fuel efficiency, a transmission efficiency, and/or a drive-train efficiency. Further, control unit 26 may determine a variety of other machine-operating conditions that may affect fuel efficiency and/or assist a driver in operating a vehicle. Such machine-operating parameters may include, for example, a vehicle speed, a load carried by the vehicle, total vehicle weight, temperature, and/or any other parameter that may affect fuel efficiency. Control unit 26 may further be configured to record and/or display one or more operating parameters.

As shown at 520, control unit 26 may next determine if the vehicle is approaching a road condition that may require a change in vehicle operating parameters (hereinafter referred to as ‘change conditions’). For example, such change conditions may include any condition that will require a driver to increase engine power, change drive ratios or gears, and/or change speeds. A change in speed may be required as a result of changing traffic conditions, changing speed limits, a stop on a travel route, a sharp curve, and/or construction. A change in power output or gear may be desired when approaching or traversing a hill and/or changing speed.

As shown at 530, if a change condition is not expected based on the machine location and information provided by trip-mapping system 46, control unit 26 will next determine if the machine is operating efficiently. If the current machine efficiency is within a desired operating range, as determined using a fuel efficiency map and/or transmission data, control unit 26 may provide an instruction to continue current operation, as shown at 540. However, if current operating conditions are determined to be inefficient (e.g. a low gear is selected or excess speed is detected), control unit 26 may determine what change is needed, as shown at 550. Further, control unit may record the occurrence of the inefficient conditions and provide instructions to a driver through display system 30, as shown at 560.

If control unit 26 determines that the vehicle is nearing a change condition, control unit 26 may evaluate the current machine-operating parameters and machine location to determine one or more efficient driving instructions, as shown at 570. The instructions may be displayed through display unit 30, as shown at 580. Further, in some embodiments, the instructions may be compared to subsequent driver performance to assist in driver evaluation. In some embodiments, the instructions may include a change in drive ratio and/or gear, or a set of operations selected to produce a certain engine power output.

As noted previously, a variety of route change conditions may occur. For example, in some embodiments, control unit 26 may identify an upcoming stop or decrease in vehicle speed based on a location determined by positioning system 34 and a destination or road conditions (e.g. construction, heavy traffic, or sharp curve) provided by trip-mapping system 46. Further, as a vehicle approaches a road location where a decrease in speed is needed, control unit 26 may be configured to output a notification via display unit 30.

As a vehicle is traveling at normal highway speeds and approaching an area where a deceleration is needed, more experienced drivers may decelerate in a manner that is more fuel efficient than less experienced drivers. For example, as a heavy truck approaches a highway exit or slow-moving traffic, it may be more efficient to allow the vehicle to decelerate by coasting without pressing the accelerator.

In some embodiments, control unit 26 may be configured to evaluate the vehicle speed as work machine 10 nears an area where deceleration is needed. Further, control unit 26 may output a signal to display unit 30 indicating the distance and/or recommending an efficient operating instruction for deceleration. For example, if the most efficient deceleration can be accomplished by coasting, control unit 26 will display a ‘coast’ instruction to the driver. Alternatively, if a change in drive ratio and/or gear, continued acceleration, or braking is needed, control unit 26 may provide an appropriate driver instruction.

Fuel-efficiency monitoring system 22 may be configured to evaluate a variety of other road conditions and/or provide instructions to assist a driver in operating work machine 10 more efficiently. As a truck enters an incline or decline, certain operations may produce more efficient driving performance than others, and fuel-efficiency monitoring system 22 may be configured to display instructions indicative of desired driver operations. Additionally, fuel-efficiency monitoring system 22 may be configured to determine if a driver is operating work machine 10 inefficiently and to provide a signal indicating the cause of the inefficiency.

In some embodiments, control unit 26 may identify an incline or decline in a road based on information from positioning system 34 and/or trip-mapping system 46. For example, as a driver approaches or enters a region having a decline the most efficient driving operation may be to maintain the current speed or to allow the vehicle to coast to obtain the fuel benefit of the down-hill driving. Therefore, control unit 26 may display an indication of the approaching decline and instruct the driver of the appropriate driving operation.

Alternatively, as a driver approaches a region with an incline, different driving operations may be selected. For example, for a relatively short hill, the most efficient operation may be to maintain a higher gear even though the vehicle may slow down substantially. For a longer hill, it may be necessary to shift to a lower gear to carry a heavy load at adequate vehicle speed. In some embodiments, control unit 26 may be configured to evaluate the grade and length of the incline, as well as the vehicle speed, to determine if a change in gear is needed.

In addition, in some embodiments, fuel-efficiency monitoring system 22 may be configured to identify when inefficient driving occurs and/or to record information related to the occurrence of inefficient driving. For example, some drivers may tend to maintain relatively high speeds as they approach an exit ramp or other area where decreased speed is needed. Therefore, fuel-efficiency monitoring system 22 may be configured to identify and record excess speed within a predetermined distance from a deceleration region.

Likewise, fuel-efficiency monitoring system 22 may be configured to detect and record a variety of other inefficient habits to assist drivers in improving driving efficiency. For example, as noted previously, using information provided by positioning system 34 and mapping system 46, fuel-efficiency monitoring system 22 may identify road conditions that lead to inefficient driving. For example, certain drivers may have a tendency to drive less efficiently when nearing a stop point, on hills, near construction, and/or near curved roadways. Other driver's may have a tendency to drive too fast on flat roadways or to use a lower gear than needed when accelerating. In some embodiments, fuel-efficiency monitoring system 22 may be configured to record the occurrence of inefficient driving conditions and to record associated road conditions and/or machine-operating characteristics. The recorded information may be stored within control unit 26 or another storage system for later access. Further, the data may be downloaded to produce a report for evaluation and/or training.

### INDUSTRIAL APPLICABILITY

The present disclosure provides a system for evaluating and improving driving performance and/or fuel efficiency. The system may be used to monitor the fuel efficiency of any highway vehicle, including for example, highway trucks.

Fuel expenditures represent a significant operating cost for highway truck fleets, and although engine and truck manufacturers have made significant design improvements to improve fuel efficiency and reduce operating costs, driver performance can significantly affect truck fuel efficiency. However, evaluating operator performance and/or training drivers to use cost-saving driving techniques can be very difficult. The present disclosure provides a system for evaluating driver performance, comparing the efficiency of driver's within a fleet, and/or identifying driver-related performance variables that may provide opportunities for improving fuel efficiency.

The system and method of the present disclosure evaluates engine and transmission-operating characteristics to determine a machine drive-train efficiency. The machine drive-train efficiency is compared to a target or optimal drive-train efficiency, which may be stored within a machine control unit. The operating efficiency for a particular driver may be stored and/or averaged to produce an efficiency score. The efficiency score of drivers within a fleet may be compared to other drivers who travel on the same or similar routes. Inefficient driving habits, such as excess speed, use of lower gears, improper down-hill accelerations, and/or excessive braking may be identified by reviewing individual driving habits and/or comparing efficiency scores of multiple drivers.

The system of the present disclosure may further include a positioning system and trip-mapping system to assist a driver in performing efficient driving. For example, the positioning system and trip-mapping system may identify upcoming changes in road conditions, such as hills, heavy traffic, a stop on a predetermined route, a necessary fuel stop, and/or a sharp curve. The fuel-efficiency monitoring system may be configured to provide instructions to drivers to improve driving efficiency. Such systems may help less experienced driver's learn more efficient driving habits. Further, the positioning system and trip-mapping system will assist more experienced drivers as they negotiate unknown routes or roads with a relatively large number of hills or curves that require frequent changes in driving.

The system of the present disclosure may further be configured to identify inefficient driving habits related to specific route conditions. For example, the system of the present disclosure may record inefficient driving, as well as associated road conditions. This may help drivers and managers identify areas for improvement.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A method for monitoring driving performance, comprising:
determining an engine fuel efficiency based on an engine speed and power output;
determining a transmission fuel efficiency based on a selected drive ratio;
determining a drive-train fuel efficiency based on the engine fuel efficiency and transmission fuel efficiency; and
comparing the drive-train fuel efficiency to a target fuel efficiency.

2. The method of claim 1, wherein the control unit is configured to compare the drive-train efficiency with an optimum drive-train efficiency and to determine an efficiency score.

3. The method of claim 2, wherein the efficiency score is a current efficiency score.

4. The method of claim 2, wherein the efficiency score is an average efficiency score for a period of machine operation.

5. The method of claim 4, wherein the efficiency score is updated at predetermined time intervals.

6. The method of claim 4, wherein the efficiency score is updated when a change in engine power output is detected.

7. The method of claim 4, wherein the efficiency score is updated when a change in drive ratio is detected.

8. The method of claim 7, wherein the efficiency score is updated when a change in gear is detected.

9. The method of claim 1, further including determining the location of a machine using a positioning system.

10. The method of claim 9, further including determining at least one machine-operating instruction based on the machine location, a machine speed, and a route to be traveled.

11. The method of claim 10, wherein the at least one machine-operating instruction includes at least one of producing an engine power output and changing a gear.

12. The method of claim 10, further including displaying the machine-operating instruction to a driver.

13. A system for monitoring driving performance, comprising:
at least one engine sensor configured to monitor at least one engine-operating parameter;
at least one transmission sensor configured to monitor at least one transmission-operating parameter; and
a control unit configured to determine a drive-train efficiency based on the at least one engine-operating parameter and the at least one transmission-operating parameter.

14. The system of claim 13, wherein the at least one engine-operating parameter includes an engine load.

15. The system of claim 13, wherein the at least one engine-operating parameter includes at least one of an engine torque, an engine speed, and a fuel rate.

16. The system of claim 13, wherein the at least one transmission-operating parameter includes a drive ratio.

17. The system of claim 16, wherein the at least one transmission-operating parameter includes a gear.

18. The system of claim 16, wherein the transmission includes a continuously variable transmission.

19. The system of claim 13, wherein the control unit is configured to compare the drive-train efficiency with a target drive-train efficiency and to determine an efficiency score.

20. The system of claim 19, further including a display unit configured to display the efficiency score to a machine operator.

21. The system of claim 19, wherein the efficiency score is an current efficiency score.

22. The system of claim 19, wherein the efficiency score is an average efficiency score for a period of machine operation.

23. The system of claim 13, further including a positioning system configured to produce a signal indicative of a machine location; and
a trip-mapping system configured to store a map of a route to be traveled.

24. The system of claim 23, wherein the control unit is configured to receive the signal indicative of the machine location and determine at least one machine-operating instruction based on the machine location, a machine speed, and the route to be traveled.

25. The system of claim 24, wherein the set of machine-operating parameters includes at least one of a change in gears and an engine power.

26. A method for improving driving performance, comprising:
determining a machine location;
evaluating current machine-operating parameters; and
determining at least one machine-operating instruction based on the machine location and operating parameters.

27. The method of claim 26, further including recording the occurrence of an inefficient driving operation and recording a road condition associated with the inefficient driving operation.

28. The method of claim 26, further including displaying the at least one operating instruction to a driver.

29. The method of claim 28, further including comparing a driver response with the displayed operating instruction.

30. A work machine, comprising:
an engine;
a transmission operably connected to the engine; and
a system for monitoring driving performance, including:
at least one engine sensor configured to monitor at least one engine-operating parameter;
at least one transmission sensor configured to monitor at least one transmission-operating parameter; and
a control unit configured to determine a drive-train efficiency based on the at least one engine-operating parameter and the at least one transmission-operating parameter.

31. The work machine of claim 30, wherein the system for monitoring engine performance further includes a positioning system configured to produce a signal indicative of a machine location; and
a trip-mapping system configured to store a map of a route to be traveled.
